(19) United States
(12) Patent Application Publication
(10) Pub. No.: US 2007/0242973 A1
(43) Pub. Date: Oct. 18, 2007

(54) DEVELOPING DEVICE AND IMAGE FORMING APPARATUS

(75) Inventor: Hirotsune YAJI, AICHI (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA BUSINESS TECHNOLOGIES, INC., Tokyo (JP)

(21) Appl. No.: 11/681,890

(22) Filed: Mar. 5, 2007

(30) Foreign Application Priority Data
Apr. 12, 2006 (JP) JP2006-109457

(51) Int. Cl. G03G 15/08

(52) U.S. Cl. 399/103

(57) ABSTRACT

An image developing device having a sealing member on an end of a developer carrier. An inner edge of the sealing member is diagonal in respect to a rotation direction of the developer carrier, which is perpendicular to an axis direction of the developer carrier.

### BACKGROUND

The present invention relates to a developing apparatus having a sealing member on an end section of a developing roller.

In an image forming apparatus such as a printer, a copying machine, a facsimile using an electrophotographic process is usually equipped with a developing cartridge. This developing cartridge has a toner storing section and a developing roller to carry the toner supplied from the toner storing section. When forming an image, the developing roller in a developing device equipped in a main body of the apparatus is rotated to supply the toner to an electric latent image formed on a photoconductive drum for forming a visible image. Then the visible image is transferred onto a transfer sheet and fixed to form a toner image.

Such developing cartridge is provide with a sealing member to prevent the toner carried on the roller from spilling out of both end sections of the roller in an axis direction caused by rotation of the developing roller. This sealing member is arranged at both end sections of the developing roller to slide with a circumferential surface of the developing roller so that the toner carried on the developing roller does not spill out through the end sections of the roller.

The sealing member is required to secure prevention of spill of the toner and consistency of roller rotation. To satisfy these requirements, there is a technology wherein tension is applied on the sealing member integrally mounted on the image forming apparatus to give an imposing force to the developing roller, whereby improving of adhesion and reduction of rotation torque are realized. (for example, refer Patent Document 1)

Also to secure the imposing force and the rotation torque, a material of the sealing member is studied. For example, a felt material formed of a TEFLON™ is used. Further, to give a durability to be capable of high speed operation of the developer carrier, for example, there is disclosed a sealing member wherein a projecting pattern of a weave is arranged diagonally on the sealing member so that the toner reached to the roller end section is returned to a developing chamber side along the pattern of the weave (for example, refer Patent Document 2).

[Patent Document 1] Unexamined Japanese Patent Application Publication No. 2-230172

[Patent Document 2] Unexamined Japanese Patent Application Publication No. 2003-107902

Meanwhile, in recent years, the developing apparatus has become compact in accordance with the downsizing of the image forming apparatus. When such a compact developing apparatus is manufactured, it has been known that installing of the aforesaid sealing member is unexpectedly attended with difficult. Namely, in the developing apparatus equipped with the sealing member of the prior art, there is a tendency that the toner spills through the end section of the roller when the developing roller is rotated, and occurrence of toner spill has not been resolved even the durability of the sealing member is improved by the prior art.

### SUMMARY OF THE INVENTION

An object of the present invention is to provide a developing apparatus where toner spill through end section of developing roller does not occur.

An aspect of the invention can be a developing device, having: an image developer carrier to rotate for carrying image developer; and a sealing member slidably disposed on a circumferential surface of the image developer carrier at least at an end section, and so that a part of an inner edge of the sealing member is diagonal in respect to a rotation direction of the image developer carrier which is perpendicular to an axis of image developer carrier and inward the axis direction.

Another aspect of the present invention can be a developing device, having: an image developer carrier to rotate for carrying image developer; and a sealing member slidably disposed on a circumferential surface of the image developer carrier at least at an end section; wherein an inside edge of the sealing member has at least one section projecting toward a center position of the image developer carrier.

### BRIEF DESCRIPTION OF THE DRAWINGS

FIG. 1 is a schematic view showing an example of a developing apparatus related to the present invention.

FIG. 2 is a schematic view showing positional relation between a developing roller and a sealing member.

FIG. 3 is a schematic view explaining an angle of a projecting section arranged diagonally.

FIG. 4 is a schematic view of an image forming apparatus with which the developing apparatus is able to be equipped.

### DETAILED DESCRIPTION OF THE PREFERRED EMBODIMENT

As mentioned above, it was found that the above problems can be resolved by providing a projecting section of the sealing member which is shaped diagonally inward on the developing roller surface or which has at least one section projecting toward a center position of the image developer carrier wherein a distance in a rotating direction of the image developer carrier from a center line of the image developer carrier to the part of the inner edge of the sealing member of downstream side in rotation direction is shorter than that of upstream side. The principle of resolving toner spill is predicted that the toner at the end section of the roller is restricted inward on the developing roller by the projecting section diagonally arranged toward a middle of the developing roller, and returned inward on the developing roller.

In the first place, a developing apparatus related to the present invention is described.

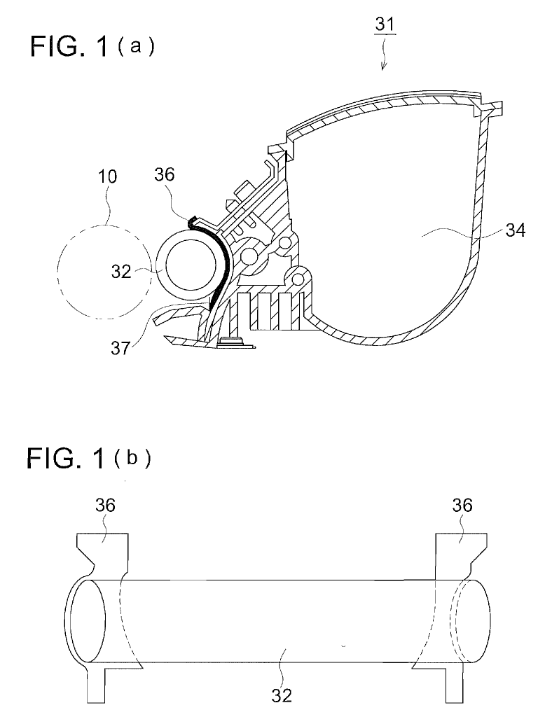

FIGS. 1 (a) and (b) are of an example of a developing apparatus of the present invention and FIG. 1(a) shows a cross section of developing apparatus 31 (hereinafter may called developing device 31). As FIG. 1(a) shows, developing device 31 is configured with developing roller 32 to supply toner to photoconductive drum 10, hopper section 34 to store the toner supplied to developing roller 32, sealing member 36 disposed to contact with developing roller 32 under a pressure, and toner restriction member 37. Toner restriction member 37 restricts an amount of the toner supplied to photoconductive drum 10 from developing roller 32, and charges the toner supplied to photoconductive drum 10.

FIG. 1 (b) is a perspective view showing developing roller 32 representing so called the developer carrier in the present invention configuring developing device 31 and sealing member 36 disposed at both end sections of developing roller 32. Sealing member 36 is disposed outside of an area where a toner layer is formed when forming an image on developing roller 32.

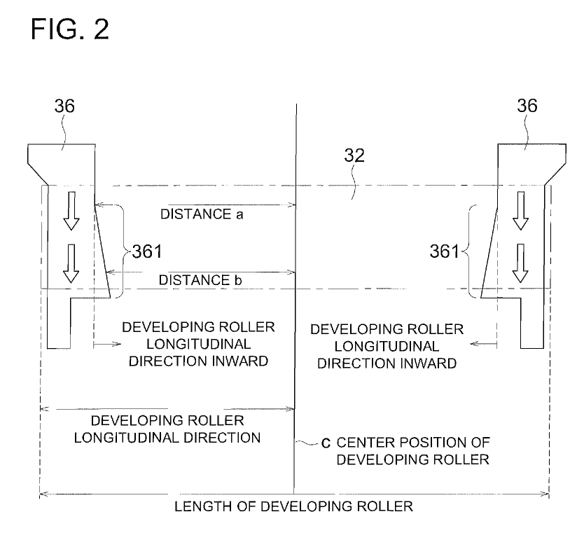

Next, FIG. 2 is a schematic view showing positional relation between developing roller 32 and sealing member 36. In the developing apparatus related to the present invention, sealing member 36 has projecting section 361 which is disposed diagonally inward in a rotating axis direction which is shown as longitudinal direction in FIG. 2 of the developing roller 32. Also, sealing member 36 is disposed in an area (in the present invention, the area adjacent to outside the toner layer forming area is called an end section of developing roller 32) adjacent to outside of an area where the toner layer is formed on developing roller 32 when forming the image. Also, the longitudinal direction of the developer carrier and the inward direction of the longitudinal direction are a direction shown by arrows with solid line in FIG. 2. Further, outline arrows in the figure show a sliding direction of a circumferential surface of developing roller 32 on sealing member 36. Also, in the figure, a center position means a position at a half length of the developing roller. While edge 361 is straight line in the figure, it can be a curved line or a line in a jagged shape, provided that pushing back of the toner to the middle section of the developing roller is not obstructed, and distance b of downstream side in the rotation direction of the developing roller is shorter than distance a of upstream side. The distances b and a are randomly selected in the projection 361. It is necessary to satisfy that the projection 361 has at least one portion satisfies the condition of distance b of downstream side in the rotation direction of the developing roller being shorter than distance a of upstream side. The sealing member is disposed at least one end of the developing roller, however as FIG. 2 shows, it can be disposed on both ends, if necessary.

Next, sealing members 36 disposed at both ends of developing roller 32 are explained. As FIG. 1 (a) shows, sealing member 36 is disposed between developing roller 32 and a developing apparatus main body. In FIG. 1(a) a curved surface is formed between developing roller 32 and the developing apparatus main body and seal section 36 is disposed along the curved surface to prevent the toner from spill through the ends of developing roller 32.

Also, as FIG. 2 shows, sealing member 36 has projecting section 361 diagonally disposed toward the middle in the rotating axis direction of developing roller 32. If sealing member 36 is disposed so that projecting section 361 directs inward in the rotating axis direction, the toner near the end sections of developing roller 32 can move inward on developing roller 32 along a diagonal edge of projecting section 361. In this way projecting section 361 moves the toner near the end sections of developing roller 32 inward on developing roller 32 so as to prevent the toner from spill through the end sections of the developing roller.

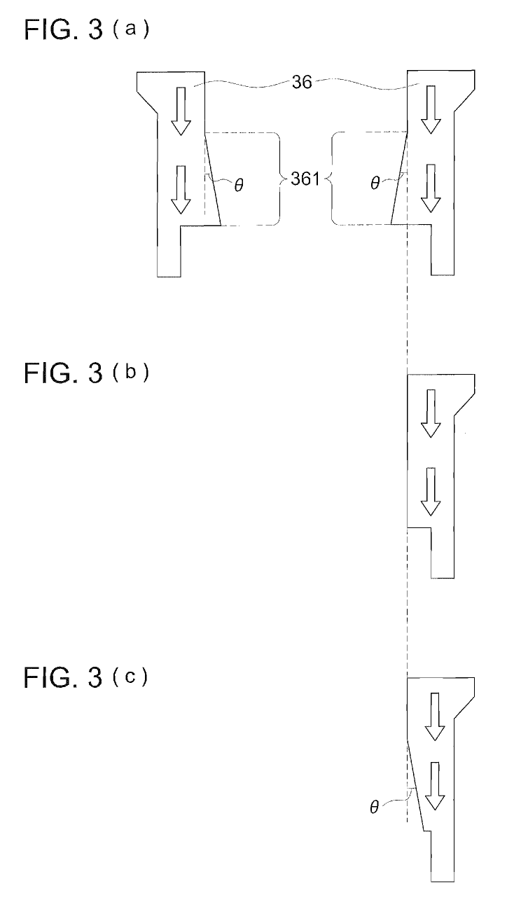

Projecting section 361 of sealing member 36 disposed diagonally can be specified by angle θ. FIG. 3 (a) is sealing member 36 having projecting section 361 disposed diagonally which can be used for the present invention, and FIG. 3(c) and FIG. 3(b) are examples which do not fall into “the sealing member having the projecting section diagonally disposed” defined in the present invention. Also, the outline arrows in the figure show the sliding direction of the circumferential surface of developing roller 32 on sealing member 36.

Angle θ between a long side of projecting section 361 and a rotation direction of developing roller (which is perpendicular to the axis direction of the developing roller) is preferred to be 5° to 45°. As shown in an example described later, if angle θ is set in the aforesaid range it is possible to prevent the spill of the toner through the ends of the developing roller surly. On the other hand, in case the sealing members shown in FIG. 3 (b) and FIG. 3 (c) are used, it is difficult to convey the toner at the end sections of the developing roller to the middle of the developing roller, then the spill of the toner through the end sections of the developing roller can not be resolved.

Also, as FIG. 1 (a) shows, a material of sealing member 36 is preferred to have some level of flexibility to be disposed along the curved surface and a resin material which can be formed in sheet-shape is exemplified as a typical material. As the materials capable of forming flexible films are, for example, vinyl based resin such as low-density polyethylene, high-density polyethylene, TEFLON™, polyester based resin such as polyethylene terephthalate, polyethylene naphthalate, polybutylene terephthalate, polyamide based resin such as nylon, and cellulose based resin such as cellulose acetate.

Also, as a method to form sheet-shaped film, for example, a cast forming is a representative method where solving resin material in a solvent, transforming the solution into a film on a glass plate and removing the solvent, a film having sheet-shape is made is. Also, biaxial stretching method to form the film where resin material is processed by stretching, and a film forming method where a thermofusion resin material is cooled to form the film are exemplified.

Also, sealing member 36 is preferred to have a thickness of 4.5 to 30.0 times of a volume-based median diameter of the toner stored in the developing device 31. By using the sealing member having the thickness in the aforesaid range, toner spill through the end sections of developing roller 32 is surly prevented. Also, since the sealing member can be arranged along curved surfaces of developing roller 32 and a casing with intimate contact, it can perform sufficient durability without occurring partial abrasion against sliding of the developing roller.

A specific thickness of sealing member 36 is, for example, in a developing apparatus using a noticeable toner having small particulates, of which the volume-based median diameter (D50) is 6.5 μm, the sealing member having a thickness of 30 μm through 195 μm is better to achieve the aforesaid result. Also, in case toner having the volume-based median diameter (D50) of 9.5 μm is used, the sealing member having the thickness of 45 μm through 285 μm is preferred to be used.

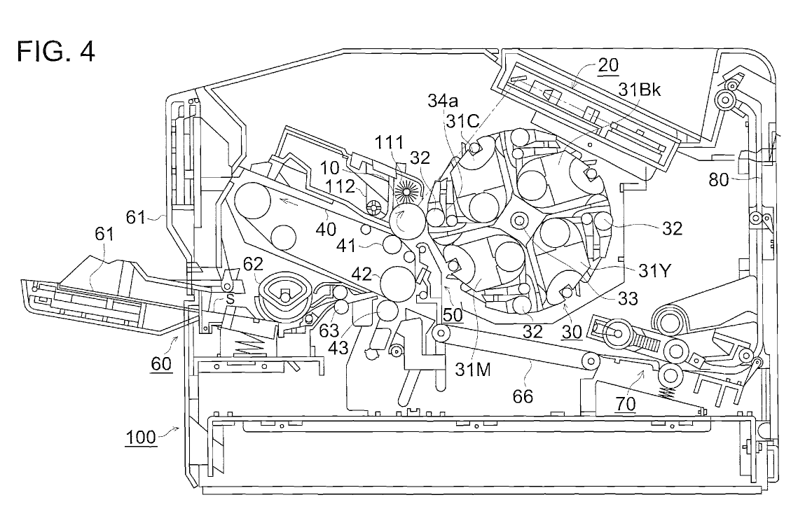

An example of a full color image forming apparatus in which developing device 31 related to the present invention can be used is shown in FIG. 4. Meanwhile, the image forming apparatus, in which developing device 31 related to the present invention can be used, is not limited to the one shown in FIG. 4. In the image forming apparatus in FIG. 4 charging brush 111 to charge a surface of photoconductive drum 10 at a predetermined voltage evenly and cleaner 112 to remove remaining toner on photoconductive drum 10 are provided in a peripheral of photoconductive drum 10, which is driven to rotate.

Laser scanning optical system 20 scans and exposes photoconductive drum 10 which is charged by charging brush 111 evenly to form a static electric latent image on photoconductive drum 10. Laser scanning optical system 20 incorporates a laser diode, polygon mirror, fθ and optical element and print data of each yellow, magenta, cyan and black color is transferred from a host computer to its control section. Then laser beams are outputted sequentially based on the aforesaid print data to scan on photoconductive drum 10 for forming the static electric latent image for each color.

Developing device unit 30 incorporating developing device 31 supplies the toner to photoconductive drum 10 on which static electric latent image is formed so as to develop an image. In developing device unit 30, four developing devices 31 Y, 31M, 31C and 31 Bk, each storing non-magnetic monocomponent toner of yellow, magenta, cyan and black respectively are equipped in a circumference of supporting axis 33, and each developing device 31 rotates centering on supporting axis 33 to be led to a position opposite to photoconductive drum 10.

Developing unit 30 rotates centering on supporting axis 33 each time when the static electric latent image of each color is formed on photoconductive drum 10 by laser scanning optical system 20 so that developing device 31 storing the toner having corresponding color is led to a position opposite to photoconductive drum 10. Then the charged toner having each color is supplied in order from each developing device 31Y, 31M, 31C and 31Bk onto photoconductive drum 10.

In image forming apparatus in FIG. 4, intermediate transfer belt 40 having an endless-shape is provided in a downstream side of developing device unit 30 in a rotation direction of photoconductive drum 10 and rotates while synchronizing with photoconductive drum 10. Intermediate transfer belt 40 is in contact with photoconductive drum 10 at a portion where first transfer roller 41 presses so as to transfer a toner image formed on photoconductive drum 10. Also, Second transfer roller 43 is disposed rotatably opposite to supporting roller 42 to support intermediate transfer belt 40. The toner image on intermediate belt 40 is transferred onto recording material S by a pressure at a portion where supporting roller 42 and second transfer roller 43 oppose each other.

Meanwhile, between full color developing unit 30 and intermediate belt 40, cleaner 50 to remove the remaining toner on intermediate transfer belt 40 are disposed which is able to be attached and detached to/from intermediate belt 40.

Sheet feeding device 60 to lead recording material S to intermediate belt 40 is configured with sheet tray 61 to store recording material S, sheet feeding roller 62 to feed the recording material S one by one and timing roller 63 to convey recording material S to second transfer section.

Recording material S on which a toner image is transferred by pressure is conveyed through conveyance device 66 configured with air suction belt to fixing device 70, then the toner image transferred by fixing device 70 is fixed onto recording material S. After fixing, recording material S is conveyed through vertical conveyance pass 80 and ejected onto apparatus main body 100.

Next, toner usable for the present invention is explained.

While the toner for use in the present invention is not limited, the toner used for non-magnetic monocomponent developing method is preferably used. Manufacturing method of the toner used for non-magnetic monocomponent developing method is not limited, though so-called polymerization toner manufactured through a process of forming a resin particle by polymerizing a polymerizable monomer in aqueous medium is preferred.

The reason is that in a manufacturing process of the polymerization toner, the toner particulate can be formed while shape and size are being controlled, whereby the toner of a small diameter having uniform size and shape can be obtained easily. The toner of a small diameter having uniform size and shape is preferred for performing pictorial image forming at a level of photograph image or reproducing a highly fine digital image which is often produced through the non-magnetic monocomponent developing method. Practical manufacturing method of the polymerization toner is disclosed, for example, in Unexamined Japanese Patent Application Publication Nos. 2000-214629, 2001-42564 and 2002-116574.

In the present invention, a thickness of sealing member 36 used for developing device 31 is 4.5 to 30.0 times of the volume-based median diameter of the toner, whereby optimal efficacy of the present invention can surly be obtained further.

The volume-based median diameter (D50v) of the toner, can be measured and calculated by Multisizer 3™ (Beckman Coulter, Inc) with an apparatus connected with a computer for data processing.

As the measuring method, after blending 0.02 g of toner and 20 m liter of solution of a surfactant (for the purpose of toner dispersion, for example, liquid solution of a surfactant where neutral detergent containing a component of the surfactant is diluted 10 times by adding pure water), ultrasonic dispersion is performed for one minute to obtain toner dispersion liquid. This toner dispersion liquid is filled through a pipette to a beaker containing ISOTON II (Beckman Coulter, Inc.) in a sample stand until measurement density becomes 5 to 10%, then a counter of the measuring instrument is set at 2500 pieces for measuring. Meanwhile, an aperture diameter of 50 μm of Coulter Multisizer™ is used. In the present invention, it is preferred to use the toner having the volume-based median diameter (D50v) of 3 to 9 μm.

### EMBODIMENT

The following specifically describes an embodiment of the present invention without being restricted by the embodiment thereof.

1. Forming of Sealing Member

Using a plastic sheet film marketed, sealing members having shapes shown in FIG. 3(a), FIG. 3(b) and FIG. 3(c) are made. Meanwhile, in respect to the sealing member having the shape shown in FIG. 3(a), angle θ and a thickness are varied as shown by a table.

Meanwhile, the following plastic sheet films are used. (1) Polyethylene film HICLEE MB (thickness 50 μm and 100 μm) by Toko Materials and Industries Co., Ltd. represented by PE in table 1. (2) Polytetrafluoroethylene film NITOFRON™ No. 906UL (Thickness 80 μm and 130 μm), by Nitto Denko Corporation represented by PTFE in table 1 (3) Polybutyleneterephthalate film, Teijin TETRON™ film C2 and H2 by Teijin Dupond Film Co., Ltd. represented by PET in table 1. As table 1 shows, sealing member No. 1 to No. 18 are made of the above films.

2. Evaluation Condition

Next, developing devices 1 to 18 shown in FIG. 1 having the developing roller which is equipped with the above sealing members 1 to 18 at both end sections shown in FIG. 2 were prepared. Meanwhile, in the developing apparatus, a predetermined amount of two kinds of black toner having the volume-based median diameter (D50v) of 5.8 μm and 6.5 μm are stored.

Developing devices 1 to 18 are installed in color laser printers “Magicolor™ 2430DL (Konica Minolta Business Technologies, Inc.) for evaluation. The evaluation is carried out while 4500 pieces of sheets are printed continuously for each developing device. More specifically, in each developing devices, sufficient amount of the black toner is charged so as to print images having a pixel ratio of 10% (an original image wherein character images having the pixel ration of 7% (each of 4 pint, 6 pint and 8 point size characters), a facial portrait, a solid white image and a slid black image, each occupies ¼ equally) on 4500 pieces of sheets continuously. As printing sheets, A4 high quality sheets (CF PAPER™ by Konica Minolta Technologies, Inc.) are used to carry out monochrome image forming. Developing devices 1 to 14 are used for practical examples and developing devices 15 to 18 are used for comparative examples.

3. Evaluation Item (Interior Taint)

After 4500 pieces of continuous printing by each developing apparatus, toner dispersal from the developing devices are evaluated visually and taint of hands which dismantled the developing device from the image forming apparatus is evaluated. The results are classified into four ranks to be judged as follow.

A: Toner adhering on upper lid of the developing device and interior taint inside the device were not observed. The hands were free from taint when the developing device is dismantled.

B: Toner adhering is not observed except slight adhering of the toner on the upper lid near the developing roller in the developing device. The hands were free from taint when the developing device is dismantled.

C: The toner adhered partially on the upper lid of the developing device, however toner dispersal inside the device was not observed. The hands were free from taint when the developing device is dismantled.

D: Toner dispersal inside the device was observed. The hands were tainted when the developing device is dismantled which required hand wash.

### <Tainted Image>

When 4500 pieces of continuous printing was carried out by each developing device, a degree of taint of images on 1000^{th}, 2000^{th}, 3000^{th} and 4500^{th} prints were evaluated. More specifically, as evaluation of 1000^{th} print, 998^{th}, 999^{th} and 1000^{th} prints, as evaluation of 2000^{th} print, 1998^{th}, 1999^{th} and 2000^{th} prints, as evaluation of 3000^{th} print, 2998^{th}, 2999^{th}, and 3000^{th} prints, and as evaluation of 4500^{th} print, 4498^{th}, 4499^{th} and 4500^{th} prints were checked by eye observation as well as through a magnifier to evaluate presence of black spots caused by dropping toner from the developing device.

A: Occurrence of the black spots is not observed in three pieces of prints.

B: The black spot is observed on one piece of print out of three pieces of prints. However, it is practically not a problem as the size of the spot is not more than 0.4 mm in diameter.

C: The black spots are observed on a plurality of pieces of prints. However, it is practically not a problem as the size of the spots is not more than 0.4 mm in diameter.

D: The black spots having size of not less than 0.4 mm in diameter were observed on a plurality of pieces of prints.

The results are shown in Table 1.

TABLE 1

| | | | | | | | Seal | | | | | |
|---|---|---|---|---|---|---|---|---|---|---|---|---|
| | | | | | | Particulate | member/toner | Taint of image | | | | |
| | Property of seal member | | | | | diameter of | particulate | (number of prints | | | | |
| | | | | θ | Thickness | toner used | diameter | in continuation) | | | | |
| | No. | Material | Shape | (°) | (μm) | (μm) | ratio | 1000 | 2000 | 3000 | 4000 | *1 |
| Example 1 | 1 | PE | a | 15 | 100 | 6.5 | 15.4 | A | A | A | A | A |
| Example 2 | 2 | PET | a | 15 | 16 | 6.5 | 2.5 | B | C | C | C | C |
| Example 3 | 3 | PET | a | 15 | 25 | 5.8 | 4.3 | A | B | B | B | B |
| Example 4 | 4 | PE | a | 15 | 50 | 6.5 | 7.7 | A | A | A | A | A |
| Example 5 | 5 | PTFE | a | 15 | 80 | 6.5 | 12.3 | A | A | A | A | A |
| Example 6 | 6 | PTFE | a | 15 | 130 | 6.5 | 20.0 | A | A | A | A | A |
| Example 7 | 7 | PET | a | 15 | 175 | 5.8 | 30.2 | A | B | B | B | B |
| Example 8 | 8 | PET | a | 15 | 250 | 5.8 | 43.1 | B | C | C | C | C |
| Example 9 | 9 | PE | a | 2 | 100 | 5.8 | 17.2 | B | B | B | C | C |
| Example 10 | 10 | PE | a | 5 | 100 | 5.8 | 17.2 | B | B | B | B | B |
| Example 11 | 11 | PE | a | 30 | 100 | 6.5 | 15.4 | A | A | A | A | A |
| Example 12 | 12 | PE | a | 45 | 100 | 5.8 | 17.2 | A | A | A | B | B |
| Example 13 | 13 | PE | a | 60 | 100 | 6.5 | 15.4 | B | B | C | C | C |
| Example 14 | 14 | PET | a | 2 | 16 | 6.5 | 2.5 | C | C | C | C | C |
| Comparative | 15 | PE | b | 0 | 50 | 6.5 | 7.7 | C | D | D | D | D |
| example 1 | | | | | | | | | | | | |
| Comparative | 16 | PE | b | 0 | 100 | 6.5 | 15.4 | B | C | D | D | D |
| example 2 | | | | | | | | | | | | |
| Comparative | 17 | PE | c | −5 | 100 | 6.5 | 15.4 | C | D | D | D | D |
| example 3 | | | | | | | | | | | | |
| Comparative | 18 | PE | c | −15 | 100 | 6.5 | 7.7 | D | D | D | D | D |
| example 4 | | | | | | | | | | | | |

*1: Occurrence of interior taint

As Table 1 shows, in examples 1 to 11, after 4500 pieces of continuous printing, interior taint and image taint were not observed at all or taint in a level of no problem was observed. On the other hand, in the comparative examples, taint becomes apparent as number of print increases, and interior taint was appeared remarkably when 4500 pieces of prints are completed.

As the above, in the embodiment related to the present invention, the sealing member having the projecting section arranged diagonally toward a middle of the developing roller, thus the toner at roller end sections is restricted and returned to the middle of the developing roller by rotating the developing roller, whereby toner spill through the end sections of the developing roller is prevented.

According to the embodiment related to the present invention, the sealing member having the projecting section is arranged diagonally toward the middle of the developing roller, whereby it is possible to realize consistent image forming without occurring toner spill through the end sections of the developing roller.

What is claimed is:

1. A developing device, comprising:
an image developer carrier to rotate for carrying image developer; and
a sealing member slidably disposed on a circumferential surface of the image developer carrier at least at an end section, and so that a part of an inner edge of the sealing member is diagonal in respect to a rotation direction of the image developer carrier which is perpendicular to an axis of image developer carrier and inward the axis direction.

2. The developing device of claim 1, wherein an angle of the part of the inner edge of the sealing member in respect to the rotation direction, which is perpendicular to an axis of the image developing power carrier, is within a range from 5° to 45′.

3. The developing device of claim 2, further comprising a toner supplying section to the image developer carrier wherein the sealing member is disposed between the image developer carrier and the toner supplying section.

4. The developing device of claim 3, wherein the sealing member is in a shape of a film having a thickness which is 4.5 to 30.0 times of a volume-based median diameter of toner included in the developer stored in the developing device.

5. The developing device of claim 4, wherein the toner has the volume-based median diameter of 3 to 9 μm.

6. The developing device of claim 1, wherein the sealing member is in a shape of a film having a thickness which is 4.5 to 30.0 times of a volume-based median diameter of toner included in the developer stored in the developing device.

7. The developing device of claim 6, wherein the toner has the volume-based median diameter of 3 to 9 μm.

8. A developing device, comprising:
an image developer carrier to rotate for carrying image developer; and
a sealing member slidably disposed on a circumferential surface of the image developer carrier at least at an end section;
wherein an inner edge of the sealing member has at least one section projecting toward a center position of the image developer carrier.

9. The developing device of claim 8, wherein a distance in a longitudinal direction of the image developer carrier from a center position of the image developer carrier to the part of the inner edge of the sealing member of downstream side in rotation direction is shorter than that of upstream side.

10. The developing device of claim 9, wherein an angle of the part of the inner edge of the sealing member in respect to the rotation direction, which is perpendicular to an axis of the image developing power carrier, is within a range from 5′ to 45′.

11. The developing device of claim 10, further comprising a toner supplying section to the image developer carrier wherein the sealing member is disposed between the image developer carrier and the toner supplying section.

12. The developing device of claim 11, wherein the sealing member is in a shape of a film having a thickness which is 4.5 to 30.0 times of a volume-based median diameter of toner included in the developer stored in the developing device.

13. The developing device of claim 12, wherein the toner has the volume-based median diameter of 3 to 9 μm.

14. The developing device of claim 13, wherein the part of the inner edge of the sealing member being diagonal in respect to the rotation direction of the image developer carrier has a curved line.

15. The developing device of claim 8, wherein the sealing member is in a shape of a film having a thickness which is 4.5 to 30.0 times of a volume-based median diameter of toner included in the developer stored in the developing device.

16. The developing device of claim 15, wherein the toner has the volume-based median diameter of 3 to 9 μm.

17. An image forming apparatus, comprising the developing device of claim 1.

18. An image forming apparatus, comprising the developing device of claim 8.
